(19) United States
(12) Patent Application Publication
(10) Pub. No.: US 2004/0153417 A1
(43) Pub. Date: Aug. 5, 2004

(54) Remotely synchronizing financial authentication

(76) Inventor: Mary Everhart, Smyrna, DE (US)

Correspondence Address: Mary Everhart, 156 Clark Farm Rd, Smyrna, DE, 19977, US

(21) Appl. No.: 10/356,899

(22) Filed: Feb. 3, 2003

(51) Int. Cl. G06F 17/60

(52) U.S. Cl. 705/67

(57) ABSTRACT

A system is disclosed which permits tokens used for finance to be checked for authenticity by having the tokens display an authentication code that varies, yet can be validated by the token validation authority. Because this code changes, it will not be stored and stolen as existing codes are. This reduces fraud for all involved where there is risk that a token might be a forgery. Because the variation is not required to be uniform in time, the system can be built without requiring continuous power and can tolerate environmental and fabrication extremes which may make exact synchronization unachievable or expensive.

### CROSS-REFERENCE TO RELATED APPLICATIONS

Not Applicable

### STATEMENT REGARDING FEDERALLY SPONSORED RESEARCH AND DEVELOPMENT

Not Applicable

### REFERENCE TO SEQUENCE LISTING, A TABLE, OR A COMPUTER PROGRAM LISTING

Not Applicable

### BACKGROUND OF THE INVENTION

Since the ancient invention of money, problems of counterfeiting have existed. These have led to ever more sophisticated measures to make the injection of false tokens representing value from succeeding. When in much more recent times credit cards were introduced, such measures were incorporated. The encryption-based controls which have evolved have however become insufficient to prevent thefts. It has become common for merchants and others to obtain card numbers and other information from credit card users, and to store it in ways which have been all too easy for thieves to steal over computer networks. This has led to an increasing problem of fraudulent charges, and to use of these numbers as a component of identity theft.

Fraudulent transactions are the most difficult to avoid where the cards are not physically present, since holograms and occasionally photos make the construction of a counterfeit card more difficult than simply counterfeiting the numbers. Rules designed to prohibit storing the secret codes have been ignored, even by large issuers (as reported in news stories) and as a result a new way to prevent fraudulent card use for remote customers is becoming necessary. Smart cards using public key encryption have been introduced, but these have met with little acceptance, due to their need for gadgetry to read them which is not widely available. This invention provides a solution to this problem and related ones, which is easily explained to all concerned and should be simple to implement as a modification to the way cards are now handled.

Prior art in the area of varying based codes reaches back to ancient times, when the password of the day was common in military camps. The notion of searching over a range of values to find a match for an unknown value is also ancient. These have not been used for financial application however.

The patent application “Time Variable Financial Authentication Apparatus” in March, 2002 is also prior art and this invention improves on it in several ways but is distinct from it. Unlike that invention, this one does not depend on time synchronization and does not require precise timing anywhere. Unlike the former invention this one will tend to follow changes in token internal state which may be moderately large and irregular, because it constantly recomputes its search value with every authentication.

### BRIEF SUMMARY OF THE INVENTION

The present invention is that one may supply a display on the consumer device (e.g., a credit card) which displays an authentication code which changes with each use. A source of use counts (e.g., a button) triggers this change and the display is generated in a different sequence for each consumer device. The authentication system at the financial processor must store the expected position in the sequence for each consumer device, and when it is presented with an authentication code, it will compare the received code with the next few displays that customer device would be expected to use. If a match is found, the device is authenticated and the position in that consumer device's number sequence is recorded for next time. Otherwise a non match is declared. If a button were used, customers would be instructed to press it only when using the device for a purchase, and a longer “distance” from the saved position in the number sequence to a match would indicate less confidence in the match. A method to reset the sequence, to be used in conjunction with a call to the financial processor to reset also the recorded position, would be provided in case the consumer device was pushed too far off from a match with the stored expected next value.

The number sequence would be determined by a secret process on each customer device, using a different secret for each device so that no two display sequences would be the same. Internally it is expected that this would be generated from a different secret key and a counter which would be incremented with a pulse source like a button. It is expected the button would connect power to the counter, cause it to increment, and power the display (and be heavily “debounced” so that one button press would “last” several seconds and prevent another counter increment for as long as possible. The process using the secret will make it impossible to deduce the internal state or predict the next display unless one is in posession of the secret.

This provides a display that changes with use, so that recording its value will be useless, and yet which would give a good indication that the consumer device was genuine. Because the numbers would change, recording them would not allow their use, and their value for identity theft would be nil. If widely used, this device would make telephone or network commerce far safer for all involved.

### BRIEF DESCRIPTION OF THE SEVERAL VIEWS OF THE DRAWING

FIG. 1 is an illustration of the back of a modified credit card which carries the invention. Notice that all fields of an existing card are present, so that the card can be used in all situations where existing cards work. However, on the card and placed so that the card can be embossed are shown a button which turns on power to the display and may also serve to increment the intenal counter, the display which a customer would report to a merchant (sometimes instead of the old card validation value), and markings showing the position of the “reset pad, This pad would be hidden under plastic and a special tool might be equipped with small pins to contact several contacts underneath the plastic when the card needed to be reset in conjunction with reset action at the authentication authority. This is a failsafe mechanism to allow recovery of the ability to authenticate this token.

FIG. 2 is a flowchart of the normal operation of the invention. It is in two parts. The first illustrates the actions on the token when it is used by a customer. The second illustrates the processing by the authentication authority when the merchant transmits the data obtained in the first part to that authority. It does not illustrate the complete credit decisioning process, but only that part of it which use of this invention entails.

### DETAILED DESCRIPTION OF THE INVENTION

On a token or consumer device which is used to indicate authority to perform transactions (like a credit card), let there be a counter and some source of pulses. The pulse source may be intermittently powered (e.g., a button) or continuously powered, but if continuous need be only approximately constant in pulse rate. It is envisioned that any pulses will be slow, not faster than a few per hour and preferably at most a few per day. The counter must be able to keep its value continuously (and might be easiest to build with a nonvolatile memory). On the token let there also be a means of performing a secret transform on this counter, which must depend on the value of the counter and on the value of a secret within the token. (In the preferred implementation, this value would depend on some other observable about the token, e.g., the credit card number.) The secret transform must be reproducible by an authentication authority, but not known to the token holder, and the secret key for each token must be different from all others and so derived that knowing one such secret is not useful in predicting other tokens' secrets. That way if one token is analyzed, the others remain secure. Optionally an authentication authority might ask that a memorized digit or digits be supplied along with those displayed, in case some resistance to stolen tokens being used should be desired.

When the token is presented to the authenticating authority, this authority receives the token number and retrieves a stored “internal counter” for that token and computes that token's display. If it matches what the customer has reported, the token is declared authentic. If not, the authenticating authority increments its “expected counter” and retries, repeating this process for a limited number of times. If a match is found, the counter value is stored by the authenticating authority; otherwise it is not. The authenticating authority will have provision to clear the stored counter, and the token must have provision to do this also (perhaps with a special tool) so that if the pulse source has been advanced too far, the token can be restored to usefulness. (It is possible, too, for the authentication authority to check numbers further in order to attempt to determine a synchronization, but this is purely optional.)

The preferred implementation of this would be on a credit card. in addition to the existing credit card fields, mag-stripe, and so on, the card would have a display, a battery, a button, and some simple electronics implementing the counter and some form of cipher, plus an encryption key which would be different in each card. One way to create such a key would be to encrypt the card number with a secret key known to the authentication authority, but never released in the field. The counter value would have to be zeroed at card creation. If any kind of pulse generator that ran continuously were used instead of a button for generating pulses, its approximate frequency and start time would need to be recorded also. These would then be used by the authentication authority to compute the lowest and highest internal counter values to be accepted. While a card was in a customer's hands, the interval between two uses would allow an expected update amount to be computed, and the fact that the backend re-establishes where the card counter is at each use means that a very cheap and inaccurate oscillator can be used. It might be powered only part time, if something like a charging capacitor and very high resistance value were used to charge from the battery, the counter starting, incrementing, and discharging the capacitor every now and then. (The time constant of such a device might be minutes or slower, so that the effective battery drain could be kept tiny.) In such cases, the button would switch the higher power consuming parts (the display for example).

When a credit card customer makes a phone or net purchase, he/she gives the credit card number and other information needed, presses the button and gives the value of the display (which might be only 3 or 4 digits long). The authentication authority is contacted by the merchant to validate the card, and this authority takes the last value of the card's internal counter, uses it to generate the internal secret (which would be used in some kind of cipher, probably a stream cipher to cut power needs and circuit complexity) and by encrypting the internal counter repeatedly generates the expected display value for this card and counter value and compares with the customer-given value. (It may also require a match to some memorized digits, which would exist at the authority but not affect the card hardware.) If there were not a match the authority would increment its expected card counter value and test again, repeating for at most a limited number of times (which might be increased one or two for every other use of the card, to account for curious examination of the display). If imprecise pulse generators were used instead of buttons, the authority would need to store times when it authenticated each card and compute a start and end internal counter range to check. This may seem more complex than button use, but would allow the system to work predictably even though card holders might show off the display out of curiosity and not limit it to when the card was in use. Precise synchronization need not be used since counter values are stored by the authority as part of the authentication sequence, so that the system will automatically follow variations in pulse generation frequency over time. (The authenticating authority can use the display number instead of the card validation code used on current credit cards (called “Card Validation Value” by Visa), as a way to save cost in processing. Only the routines within its card validation which check a validation number need be touched if this is done.)

Because power need not be applied constantly (or full power need not be) and the system tolerates drift, there should be little difficulty finding a battery that can power such a device for a few years.

It is good practice for the display values to be related mathematically to something observable about the token, so that the authentication authority can more quickly compute internal secrets. However, if it is desired to avoid display of a real credit card number on a token which might be combined with an RF transponder, for example, this need not be done. However, the token number could be set up to be mathematically derived from the original (with, for example, a cipher) and made to look like a credit card number, or simply associated at the authentication authority, which would look up the true card number before performing any other authentication steps.

The display would typically be 3 to 5 digits if it is to be used in place of a Card Validation Value. A longer display is preferable to allow more drift in the counter to be accommodated. If for example a range of 100 counter values needed to be checked, that is only 0.1% of the number range of a 5 digit display, but 10% of a 3 digit display. The wider display gives better assurance of the token's genuineness.

Definitions

“Display”, as used above, means whatever sends information off the token for authentication checks. For credit cards, this would be some visible display. For other types of tokens, the display might be a radio or audio signal, or magnetic patterns also. The checking is in all cases to be done off the token, although a central authority might be replaced in some cases by some combination of other processing with perhaps other tokens whose trust is established in other ways (biometrics, perhaps) to allow local checking of such tokens for authenticity.

“Authenticating authority” as used here means either a central authority (as in the preferred implementation) or a distributed one capable of deciding whether to authorize transactions where a token is provided as a way to permit them.

“Authority to perform transactions” in the scope of this invention means designating posessing some means of payment or authority to pay for something, or other financial authority of similar nature.

“Token” means a device which is presented or which bears information which is presented by someone to set up payment or similarly authorize some financial or financial-related transaction. For example, a credit card is a token. A gasoline-buying “fastpass” is also a token.

### DRAWINGS

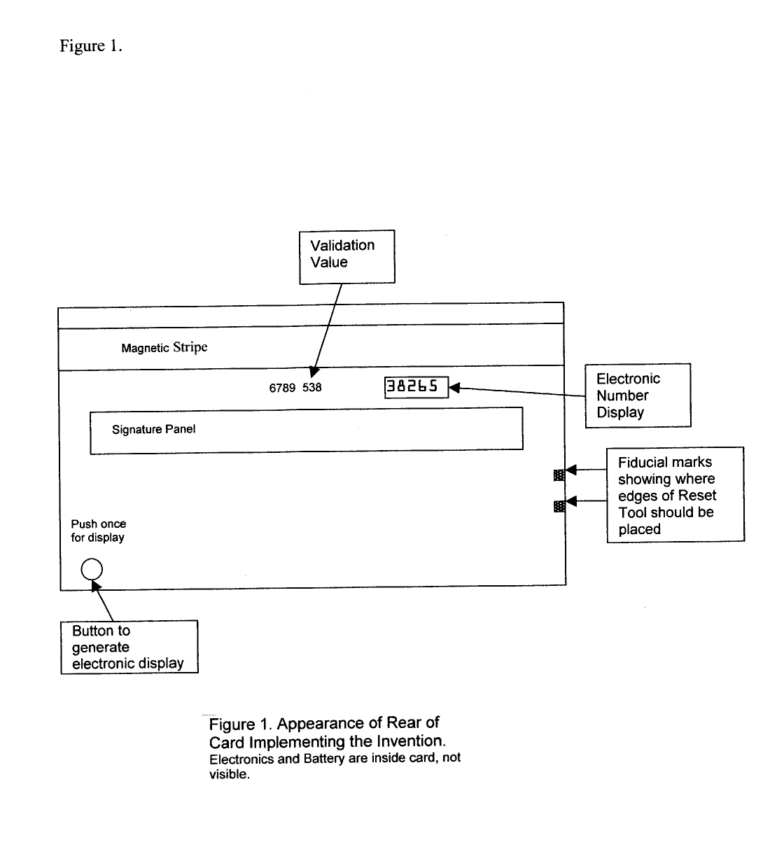

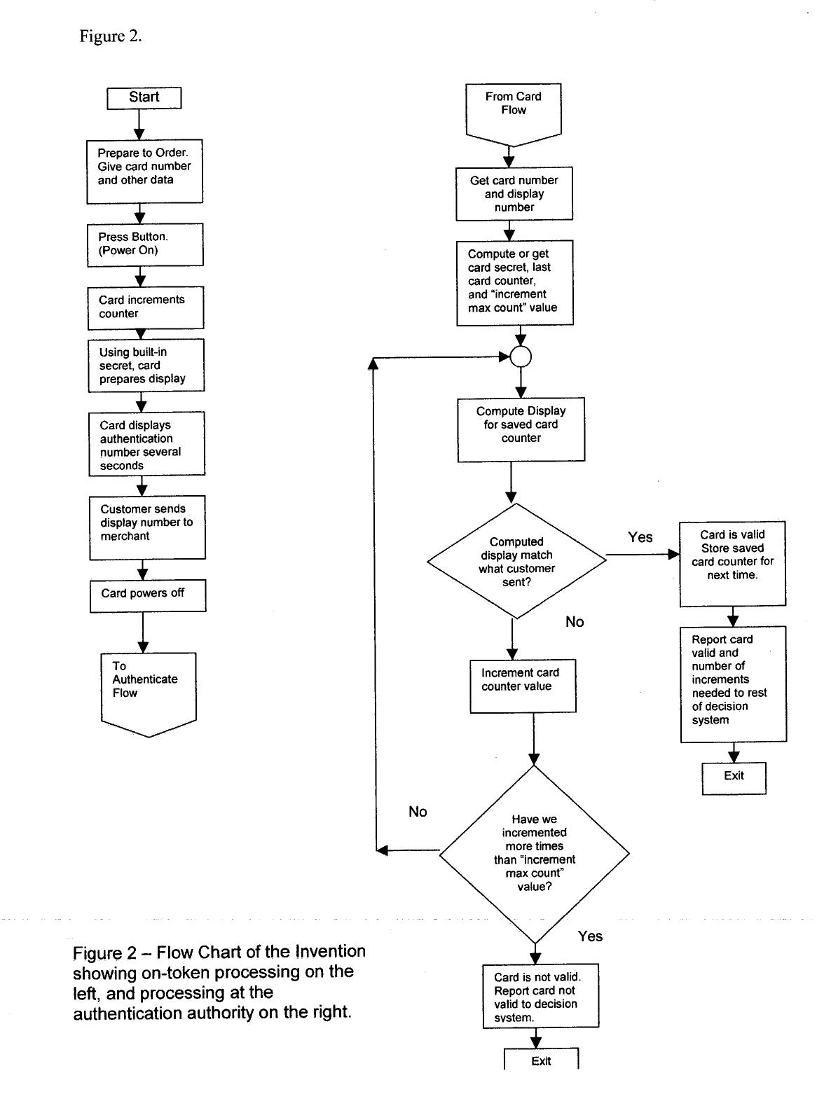

Attached are FIG. 1 and FIG. 2, the drawings.

1. What I claim as my invention is a method for authenticating finance or finance related transactions, consisting of
a. a token device which contains a counter which is incremented by a pulse source and a pulse source which is manually driven (as for example a button and debouncing circuitry), and
b. logic capable of transforming this counter's values by means of a process involving a secret known to itself and an authenticating authority into a sequence of numbers such that the transformed values of the counter cannot be predicted without possession of the secret, and
c. a display of all or part of the transformed value, which is
d. reported along with other information from the token (and optionally with additional memorized information from the token holder) which will identify it to the authenticating authority, which
e. uses a copy of its stored value of the token's counter, and
f. duplicates the transforming logic in the token and
g. compares the part of the transformed value reported (from step d above) with its computation and
h. uses equality of these to verify that the copy of the token is legitimate (storing the token counter value if so), or if equality is not found increments its stored value of the token's counter and repeats steps f, g, and h a number of times before declaring the token illegitimate, and
i may use optional additional information memorized by the token holder and sent in step d to validate that the token holder is the authorized one.

2. The invention of claim 1 where the display is human readable.

3. The invention of claim 1 where the token is used for authentications of token holders for only payment processing, the transactions specifically having to do with money.

4. The invention of claim 1 where no optional data memorized by the token holder is used.

5. The invention of claim 1 where the token used is not internally secure and where a second identifier built into the token is used mathematically for the computation of the values displayed by the display, and where the second identifier is read independently and the value used by the authenticating authority to ensure the token was not forged.

6. A method for authenticating finance or finance related transactions, consisting of
a. a token device which contains a counter which is incremented by a pulse source and a pulse source where the pulse source is not manually driven, such as a pulse generator which operates at an approximately known rate, and
b. logic capable of transforming this counter's values by means of a process involving a secret known to itself and an authenticating authority into a sequence of numbers such that the transformed values of the counter cannot be predicted without possession of the secret, and
c. a display of all or part of the transformed value, which is
d. reported along with other information from the token (and optionally with additional memorized information from the token holder) which will identify it to the authenticating authority, which
e. uses its stored value of the token's counter, and
f. duplicates the transforming logic in the token and
g. computes the range of expected counter values from this stored token counter, pulse generator properties, and other information including possibly the time of last authentication for this token and the current time, and h. For each counter value within this expected range of values,
i. compares the part of the transformed value reported (from step d above) with its computation and
j. uses equality of these to verify that the token is legitimate, and if legitimate proceeds to step k, and
k. stores the value found for the token counter if equality was found (and stores any other information needed for future authentications, which may include the time of this authentication), and
l. may use optional additional information memorized by the token holder and sent in step d to validate that the token holder is the authorized one.

7. The invention of claim 6 where the display is human readable

8. The invention of claim 6 where the token is used for authentications of token holders for only payment processing, the transactions specifically having to do with money.

9. The invention of claim 6 where no optional data memorized by the token holder is used.

10. The invention of claim 6 where the token used is not internally secure and where a second identifier built into the token is used mathematically for the computation of the values displayed by the display, and where the second identifier is read independently and the value used by the authenticating authority to ensure the token was not forged.
